(19) United States
(12) Patent Application Publication
(10) Pub. No.: US 2026/0179077 A1
(43) Pub. Date: Jun. 25, 2026

(54) SYSTEMS AND METHODS FOR GENERATING INDICATORS FOR FACILITATING NFC INTERACTIONS

(71) Applicant: American Express Travel Related Services Company, Inc., New York, NY (US)

(72) Inventors: Alaric M. Eby, Scottsdale, AZ (US); Sunny D. Hirani, Phoenix, AZ (US); Mukund Shankar SimhaRaghu, Glendale, AZ (US)

(21) Appl. No.: 18/990,093

(22) Filed: Dec. 20, 2024

(51) Int. Cl. G06Q 20/32; G06Q 20/20; G06Q 20/36

(52) U.S. Cl. CPC G06Q 20/3278; G06Q 20/20; G06Q 20/3224; G06Q 20/36

(57) ABSTRACT

Various systems and methods are described for generating indicators for facilitating near field communication (NFC) interactions. In some examples, a system is configured to identify intent to initiate a transaction with a point-of-sale (POS) device and initiate an image stream using a camera to capture a view of the POS device. A POS device type in the image stream is identified based at least in part on a visual object detected in the image stream. An antenna location for the POS device is determined based at least in part on the POS device type and an inventory of POS terminals. The system is configured to augment the image stream to include a visual terminal indicator for a terminal antenna field based at least in part on the antenna location of the POS device.

### BACKGROUND

Contactless payments at point-of-sale devices have emerged as a convenience, secure payment mechanism for customers making purchases at physical retail stores. In some cases, the contactless payments is a faster payment process than previous methods payment card interacts. Additionally, contactless payments can be performed with a payment instrument that can include a payment card, a smart phone device, a wearable device, and other suitable payment instruments.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a contactless payment interaction according to various embodiments of the present disclosure.

FIG. 2A is a drawing of a network environment according to various embodiments of the present disclosure.

FIGS. 2B and 2C are drawings depicting approaches for locating an antenna location for a contactless payment

FIG. 3 is a flowchart illustrating one example of functionality implemented as portions of an application executed in a client device in the network environment of FIG. 2 according to various embodiments of the present disclosure.

FIG. 4 is a flowchart illustrating one example of functionality implemented as portions of an application executed in a client device in the network environment of FIG. 2 according to various embodiments of the present disclosure.

FIG. 5 is a flowchart illustrating one example of functionality implemented as portions of a merchant application executed in a point-of-sale device in the network environment of FIG. 2 according to various embodiments of the present disclosure.

### DETAILED DESCRIPTION

The various embodiments of the present disclosure relate to approaches for generating indicators for facilitating contactless payment interactions on a point-of-sale (POS) device. Contactless payments at POS devices have emerged as a convenient, secure payment mechanism for customers making purchases in at physical retail stores. Contactless payments can be performed with a payment instrument that can include a payment card, a smart phone device, a wearable device, and other suitable payment instruments. However, when attempting to a make a contactless payment, customers can struggle with identifying an antenna location for initiating the interaction between a customer payment instrument and the antenna for the POS device. In some instances, the electromagnetic field at the antenna location can have a relatively small reception range (e.g., less than four inches) from a surface of the POS device. As such, when the POS device lacks a clear visual indicator for the antenna location, the customer can struggle to active the contactless payment because their payment instrument is not within the reception range of the antenna.

Accordingly, the various embodiments of the present disclosure provide several advantages over existing contactless payment mechanisms. For example, the various embodiments can include a client-side application that is configured assist a user with identifying an antenna location on the POS device. The client-side application can generate one or more of visual indicators, audible indicators for guiding a user to move their payment instrument to the antenna location on the POS device.

In another example, the various embodiments can include a POS device that are configured to provide dynamic feedback indicators for assisting a user identify an antenna location for a contactless payment. In some instances, the feedback indicators can be provided to a client device to facilitate with the location of the antenna.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

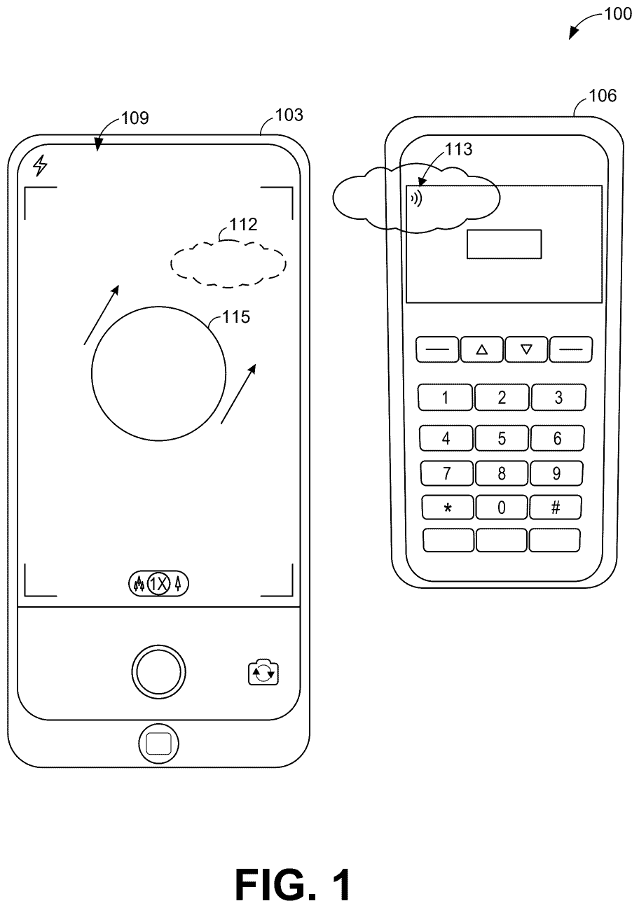

As illustrated in FIG. 1, shown is a drawing of a user attempting to make a contactless transaction in a network environment 100. The network environment 100 includes a client device 103 and a point-of-sale (POS) device 106. The user can activate their client device 103 to initiate a contactless payment with the POS device 106. Upon activating the client device 103 for the contactless payment, the client device 103 can display a user interface 109 that includes a live video view (e.g., a live camera feed), which is provided by a camera on the client device 103.

In the live video view, the client device 103 can identify a POS device 106 and determine a POS device type (e.g., model, brand) of the POS device 106. After the POS device type, the client device 103 can augment the live video view to include visual indicators to assist the user in making a contactless transaction (e.g., an NFC transaction). For example, a visual terminal indicator 112 can represent a merchant reception range (e.g., a terminal antenna field) of an antenna location 113 for the POS device 106 used to make contactless payments based at least in part the antenna location on the POS device 106. Additionally, the user interface 109 includes a visual device indicator 115 representing a client reception range (e.g., a device antenna field) of a client antenna for the client device 103. With the visual indicators, the user interface 109 can assist the user in overlapping the visual terminal indicator 112 with the visual device indicator 115. Based on the overlapping of the visual indicators, the client device 103 and the POS device 106 can initiate a contactless payment. As such, the user interface 109 can represented an augmented reality user interface 109. The augmented reality user interface 109 can include one or more augmented visual components for assisting the user with locating the antenna location 113 of the POS device 106, which is enable the user to make contactless payment in a faster manner.

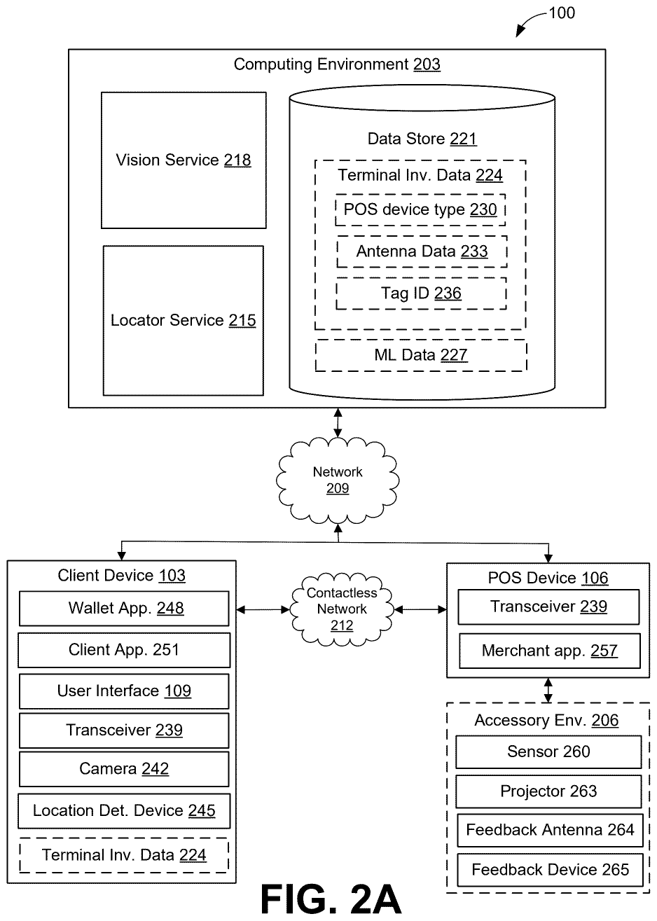

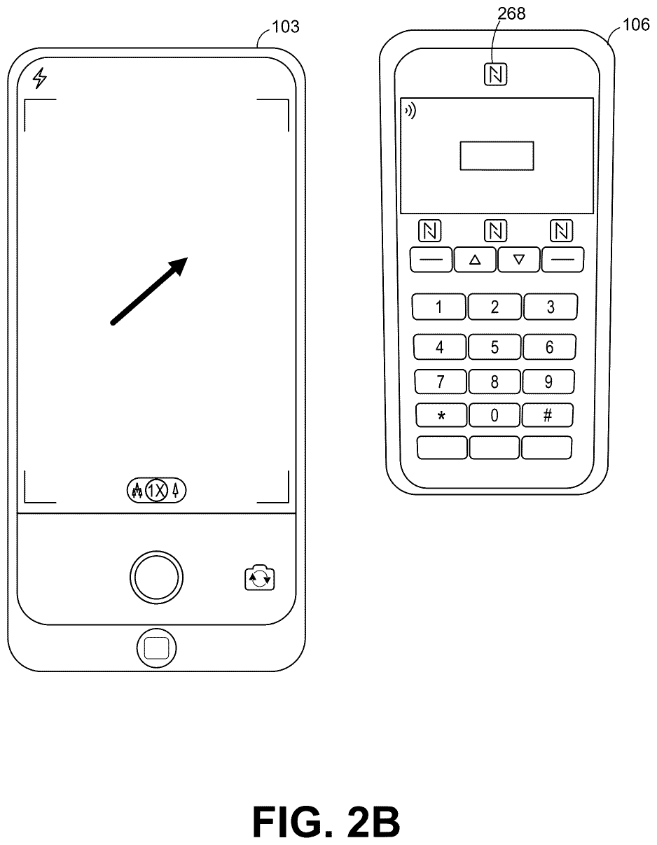

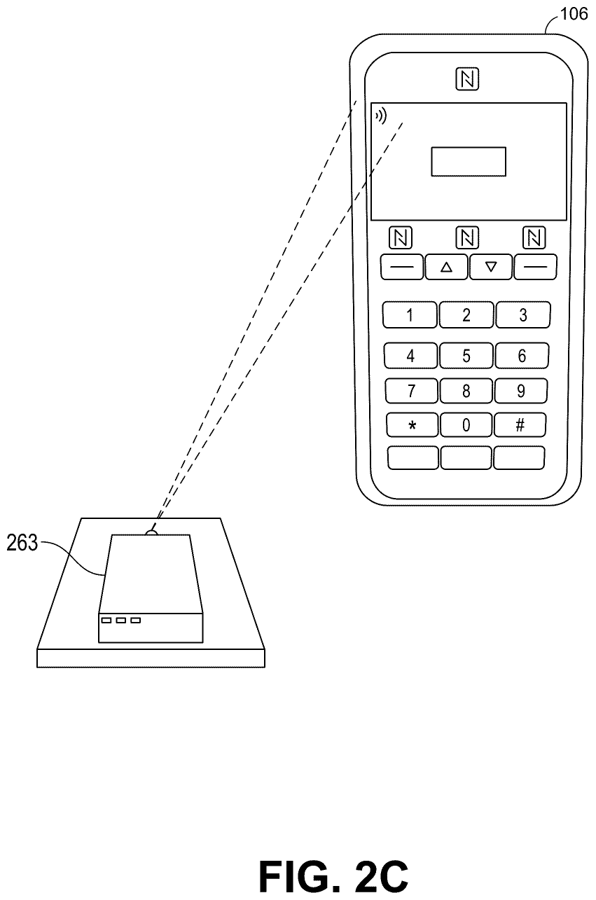

With reference to FIG. 2A, shown is a network environment 100 according to various embodiments. The network environment 100 can include a computing environment 203, a client device 103, a point-of-sale (POS) device 106, and an accessory environment 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The client device 103 and the POS device 106 can be in data communication by way of a contactless network 212. The contactless network 212 can enable direct communication between the client device 103 and the POS device 106 without the involvement of the network 209. In some examples, the contactless network 212 can represent one or more near field communication (NFC) protocols, one or more BLUETOOTH protocols, and other suitable local contactless networks 212. The contactless network 212 can be used to execute a contactless payment. One non-limiting examples of contactless payment would be according to Europay, Mastercard, and Visa (EMV) contactless payment standard.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a locator service 215, a vision service 218, and other applications, services, processes, systems, engines, or functionality not discussed in detail herein.

The locator service 215 can be executed to facilitate a user with locating an antenna location 113 for performing a contactless payment. The locator service 215 can be in data communication with the client device 103 and/or the POS device 106. The locator service 215 can interface with the vision service 218 for assistance with identifying objects in an image stream generated by the client device 103.

The vision service 218 can be executed to assist the locator service 215 with providing indicators for an antenna location 113 on the POS device 106. The vision service 218 can act as an intermediary for interacting with one or more machine learning models (e.g., computer vision model), which can be used for object detection, object classification, and other suitable computer vision techniques.

Also, various data is stored in a data store 221 that is accessible to the computing environment 203. The data store 221 can be representative of a plurality of data stores 221, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 221 is associated with the operation of the various applications or functional entities described below. This data can include terminal inventory data 224, machine learning data 227, and potentially other data.

The terminal inventory data 224 can represent data associated with POS devices 106 at store locations. The terminal inventory data 224 can include POS device type 230, antenna data 233, tag identifier 236, and other suitable data. The terminal inventory data 224 can also be provided to the client device 103. In some examples, the terminal inventory data 224 can be generated by obtaining specifications of various POS device 106.

The POS device type 230 can data associated various types of POS devices 106. The POS device types 230 can include specifications data, dimensions, capabilities, features and other suitable aspects of various types of POS devices. In some examples, the POS device type 230 can include data associated with identifiable visual components of the POS device 106, such as device logos, distinctive visual shapes, distinctive markings, distinctive buttons, distinctive use interfaces, and other suitable distinctive visual aspects of the POS device 106.

The antenna data 233 can include data relating to an antenna configured executing contactless payments for the POS device 106. The antenna data 233 can include an antenna identifier for the POS device 106, an antenna location 113, an antenna field dimension, physical dimensions of the antenna, wireless protocols supported (e.g., NFC, BLUETOOTH, etc.), and other suitable data.

The tag identifier 236 can data relating to a sticker or a tag that operates on a wireless protocol tag, the sticker or tag can be positioned on or nearby the POS device 106. The tag identifier 236 can be a reference location on the POS device with respect to an antenna location 113. For example, the POS device 106 can include a first NFC tag with a first tag identifier 236 and a second NFC tag with a second tag identifier 236. The first NFC tag can be situated above an NFC antenna location and the second NFC tag can be situated below the NFC antenna location. If either one of the first tag identifier 236 or second tag identifier 236 can be read, then the client device 103 can determine the antenna location 113 based at least in part on one of the tag identifiers 236 providing a known reference location with respect to the antenna location 113.

The machine learning data 227 can represent data associated with generating, validating, and deploying machine learning models (e.g., computer vision models, image classification models) used for identifying POS devices 106, different components (e.g., antenna location 113), of the POS device 106, and other suitable aspects of the POS device 106. For example, machine learning models can be generated and used by the locator service 215 to identify a particular brand and model of the POS device 106 from an image stream captured by the client device 103. In some examples, the machine learning models can be deployed to the client device 103.

The client device 103 is representative of a plurality of client devices that can be coupled to the network 209 or can communicate via the contactless network 212. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client device can also include a transceiver 239, a camera 242, a location detection device 245, and other suitable components. The transceiver 239 can represent one or more components that communicate according to various wireless communication protocols. For example, the transceiver 239 can represent a near field communication (NFC) transceiver that communicates according to one or more NFC communication protocols with the POS device 106. In this instance, the contactless network 212 can represent one or more NFC communication protocols that are used to execute a contactless transaction between the client device 103 or a payment card and the POS device 106. The transceiver 239 can represent other wireless transceivers for BLUETOOTH protocol, Wi-Fi protocol, cellular protocol, and others suitable wireless transceivers.

The camera 242 can represent a sensor device that is configured to capture images and video. The camera 242 can be used by one or more applications executed on the client device 103 to provide augmented reality views, in which visual components can be superimposed over an image stream (e.g., live camera feed, a collection of images).

The location detection device 245 can represent a device for determining a present location of the client device 103. The location detection device 245 can also provide historical location data for the client device 103. The location detection device 245 can represent a global position system (GPS), a global navigation satellite system (GLONASS), and other suitable devices for determining the location of the client device 103. The location device 245 can also represent a component that uses triangulation to determine location using data from one or more sources, such as beacon devices, Wi-fi devices, and other suitable triangulation devices.

The client device 103 can be configured to execute various applications such as a wallet application 248, a client application 251, or other applications. The wallet application 248 can be configured to store payment instruments and/or execute payment transactions with the POS device 106. The wallet application 248 can be executed to facilitate locating an antenna location 113 of the POS device 106 for executing contactless transactions. The client application 251 can be executed in a client device 103 to access network content served up by the computing environment 203 or other servers, thereby rendering a user interface 109 on the display. To this end, the client application 251 can include a browser, a dedicated application, or other executable, and the user interface 109 can include a network page, an application screen, or other user mechanism for obtaining user input. The client device 103 can be configured to execute applications beyond the client application 251 such as email applications, social networking applications, word processors, spreadsheets, or other applications. In some examples, the client device 103 can store terminal inventory data 224.

The POS device 106 can represent a device or terminal for executing contactless transaction at a merchant store. The POS device 106 can include the transceiver 239 for executing contactless transactions with the POS device 106. The POS device 106 can execute a merchant application 257 for executing contactless transaction and for assisting a user with locating the antenna location 113 for executing the contactless transaction.

The accessory environment 206 can represent one or more accessory devices in a merchant environment at a merchant store. The accessory environment 206 can include a sensor 260, a projector 263, a feedback antenna 264, a feedback device 265 (e.g., lighting device, speaker, etc.), and other suitable components at the merchant store. The sensor 260 can represent a camera, a motion sensor, a touch-screen user interface, and other suitable devices for detecting a presence of the user at the POS device 106 and for detecting user actions at the POS device 106. The projector 263 can represent a lighting device that project images of models on, near-by, and/or at a surrounding area of the POS device 106. The projector 263 can project images for assisting a user with identifying an antenna location 113 on the POS device 106. The feedback antenna 264 can be an antenna for receiving an RF signal from wireless tags positioned around the antenna location 113 for executing a contactless location. When a wireless tag is activated, the feedback antenna 264 can identify the wireless tag has been activated and the POS device 106 can use a feedback device 265 to generate a feedback indicator for the user.

The feedback device 265 can include a user interface, a speaker, a video projector, and other suitable devices. The feedback device 265 can present feedback indicators at the POS device 106 to assist the user with locating the antenna location 113 on the POS device 106.

Next, a general description of the operation of the various components of the network environment 100 is provided. To begin, the user can activate their client device 103 to initiate a contactless payment with the POS device 106. Upon activating the client device 103 for the contactless payment, the wallet application 248 can display a user interface 109 that includes a video view (e.g., a real-time video camera feed), which is provided by the camera 242.

In the camera view for the user interface, the wallet application 248 can identify a POS device 106 and determine a POS device type 230 (e.g., model, brand, etc.) of the POS device 106. After the POS device type 230 has been identified, the wallet application 248 can augment the camera view to include visual indicators to assist the user in making a contactless transaction (e.g., an NFC transaction). For example, the visual terminal indicator 112 can represent a merchant reception range (e.g., a terminal antenna field) of an antenna for the POS device 106. The wallet application 248 can estimate the merchant reception range used to make contactless payments based at least in part the antenna location 113 on the POS device 106 and an estimated dimensions for the wireless protocol. Additionally, the user interface 109 includes a visual device indicator 115 representing a client reception range (e.g., a device antenna field) of a client antenna for the client device 103. The wallet application 248 can estimate the client reception range based at least in part on the client antenna location and an estimated dimensions for the wireless protocol. With the visual indicators, the user interface 109 can assist the user in overlapping the visual terminal indicator 112 with the visual device indicator 115. Based on the overlapping of the visual indicators, the wallet application 248 can initiate a contactless payment with the POS device 106 because of the transceiver 239 of the client device 103 is within reception range of the transceiver 239 of the POS device 106. As such, the user interface 109 can represent an augmented reality user interface 109. The augmented reality user interface 109 can include one or more augmented visual components for assisting the user with locating the antenna location 113 of the POS device 106.

Referring next to FIG. 2B, shown is another example of the networked environment 100. In this example, the POS device 106 is equipped with multiple wireless tags 268 (e.g., an NFC tag sticker) which are each situated at different known locations on or near-by the POS device 106.

In this example, the wallet application 248 can be activated to initiate a contactless transaction with the POS device 106. As part of the initiation process, the wallet application 248 can cause the transceiver 239 (of the client device 103) to transmit a radio frequency signal toward the POS device 106, in which the RF signal is intended for the antenna of the transceiver 239 (of the POS device 106).

However, the RF signal does not interact with the antenna location 113 on the POS device 106. Instead, the RF signal can interact with one of the wireless tags 268 on the POS device 106. In response to receiving the RF signal, the wireless tag 268 can transmit a tag identifier 236 to the wallet application 248.

The wallet application 248, via the transceiver 239, can receive the tag identifier 236. The wallet application 248 can determine a reference location associated with the tag identifier 236. The wallet application 248 can generate a feedback indicator based at least in part on the reference location. The feedback indicator can indicate a direction of the antenna location 113 with respect to the reference location. In some examples, the wallet application 248 receives a receive strength signal indicator (RSSI) from the wireless tag. The wallet application 248 can determine a distance to the antenna location 113 based at least in part on the RSSI and the refence location.

In other examples, the accessory environment 206 includes a feedback antenna 264 and a feedback device 265. When a user positions their payment instrument (e.g., a client device 103 or an NFC-based payment card) near one of the wireless tags, the wireless tag can transmit data (e.g., tag identifier 236) that can be received by the feedback antenna 264. The POS device 106 can receive the data and generate a feedback signal (e.g., a visual indicator, an audible indicator) presented to the user via the feedback device 265. For example, if the top wireless tag detects an NFC-based payment card, the top wireless tag can transmit a first tag identifier 236. The feedback antenna 264 can receive a signal for the first tag identifier 236. The merchant application 257 can identify the signal for the first tag identifier 236 and can cause the feedback device 265 to present a feedback signal (e.g., an audible signal on a speaker, a visual signal on a user interface) for the user to move the NFC-based payment card lower.

Turning now to FIG. 2C, shown is another example of the networked environment 100. In FIG. 2C, a user approaches a POS device 106. The merchant application 257 can detect the presence of the user at the POS device 106 and can determine an intent of the user to make a contactless payment using one or more sensors 260 (e.g., store camera, POS camera, a proximity sensor). In some examples, the intent of the user to make a contactless payment can be determined using objected detection of one or more camera images provided from a store camera and/or a POS camera. One of these cameras can detect hand and arm movements. In another example, the merchant user interface of the POS device 106 can be receive a selection of a user to pay with a payment card.

Upon the detection of the intent to make a contactless payment, the merchant application 257 can active a projection of the antenna location 113 for the user using the projector 263. In some examples, the projection can be displayed on a surface of the POS device 106 as to where the antenna location 113 is located. In other examples, the projection can be near-by the POS device 106. In some examples, the projection can be a two-dimensional or a three-dimensional representation of the antenna location. Some non-limiting examples of the projection can be a dome-shape image or a laser-grid type of image. The projector 263 can generate the projection based at least in part on a two-dimensional or a three-dimensional model.

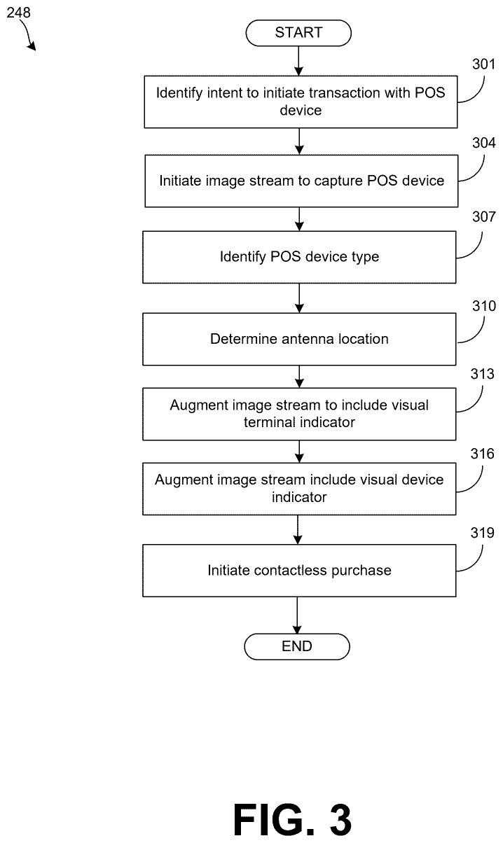

Referring next to FIG. 3, shown is a flowchart that provides one example of the operation of a portion of the wallet application 248. The flowchart of FIG. 3 provides merely an example of the many different types of functional arrangements that can be employed to implement the operation of the depicted portion of the wallet application 248. As an alternative, the flowchart of FIG. 3 can be viewed as depicting an example of elements of a method implemented within the network environment 100. Alternatively, the flowchart of FIG. 3 can be performed by the client application 251.

Beginning with block 301, the wallet application 248 can identify an intent to initiate a transaction with the point-of-sale (POS) device 106. The wallet application 248 can identify the intent in various manners. For example, the intent to initiate the transaction can be represented by an activation of the wallet application 248 or a selection of a user interface component (e.g., locate NFC antenna user interface button) within the wallet application 248. In other examples, the intent can be identified based at least in part on a successful biometric scan of the user, a selection of a payment instrument in the wallet application 248, or other suitable conditions of intent to make a purchase.

In block 304, the wallet application 248 can initiate an image stream (e.g., a live camera feed) using the camera 242 to capture a view of the POS device 106 based at least in part on the identification of the intent to initiate the transaction. In some examples, the wallet application 248 can display a live view from the camera 242 of the surrounding of the client device 103. For instance, the user may be holding the client device 103 up in a manner in which the live view can includes a view of the checkout area of the store location.

In block 307, the wallet application 248 can identify a POS device type 230 of the POS device 106 in the image stream based at least in part on a visual object detected in the image stream. In some examples, the wallet application 248 can use the locator service 215 and/or the vision service 218 to first identify the POS device 106 within the image stream. Then, the identified POS device 106 can be further analyzed to identify a POS device type 230. The locator service 215 and/or the vision service 218 can interface with a machine learning model (e.g., a computer vision model) to identify the POS device 106 and the POS device type 230. In some examples, the wallet application 248 can interface with a machine learning model to determine the POS device 106 and the POS device type 230 on the client device 103. The machine learning model can be trained to identify the POS device 106 and the POS device type 230.

In some examples, the wallet application 248 can further determine the POS device type 230 based at least in part on a present location of the client device 103 within a store location. The present location can be generated using the location detection device 245 of the client device 103.

In block 310, the wallet application 248 can determine an antenna location 113 for the POS device 106 based at least in part on the POS device type 230 and an inventory of POS terminals (e.g., terminal inventory data 224). After the POS device type 230 has been identified, the wallet application 248 can access the terminal inventory data 224 to determine the antenna location 113 on the POS device 106. In some examples, the antenna location 113 can be represented as having one or more size dimensions. The antenna location 113 can be represented as a distance from a physical component of the POS device 106. For instance, the antenna location 113 can be represented as one or more distances from an edge, a side, a POS user interface, or other suitable component of the POS device 106.

In block 313, the wallet application 248 can augment the image stream to include a visual terminal indicator 112 for a terminal antenna field based at least in part on the antenna location 113 of the POS device 106. In some examples, the augmentation can include identifying one or more components of the POS device 106 as reference points. Using the reference points, the wallet application 248 can generate a visual terminal indicator 112 for the antenna location 113. The visual terminal indicator 112 can be represented as at least one of a portion of a spherical shape, or a cube shape based at least in part on the antenna location 113. The visual terminal indicator 112 can also be illustrated a two-dimensional illustration or a three-dimensional illustration. The visual indicators can be superimposed over the live camera view.

In block 316, the wallet application 248 can augment the image stream to include a visual device indicator 115 representing a device antenna field of the client device 103. In the user interface 109, the wallet application 248 can illustrate the visual device indicator 115 and the visual terminal indicator 112 to assist in guiding the user to move the client device 103 in a reception range of the antenna location 113 (e.g., the visual terminal indicator 112). The visual indicators can be superimposed over the live camera view. As such, the wallet application 248 causes the user interface 109 to present an augmented view of the image stream in which the visual indicators can be superimposed over the image stream.

In some examples, the wallet application 248 can generate a feedback indicator that provides a moving instruction for overlapping the visual device indicator 115 with the visual terminal indicator 112. The feedback indicator can include a visual component, an audible indicator, a haptic indicator or other suitable feedback indicator for indicating a direction for moving the client device 103 toward the antenna location 113 of the POS device 106.

In block 319, the wallet application 248 can initiate a contactless purchase based at least in part on a position of the client device 103 with respect to the visual terminal indicator 112. For example, upon the client device 103 being within a reception range of the antenna location 113 for the POS device 106, the POS device 106 and the client device 103 can execute a contactless transaction. In some examples, the contactless transaction is executed using an NFC communication protocol. Then, the wallet application 248 can proceed to the end of the depicted process.

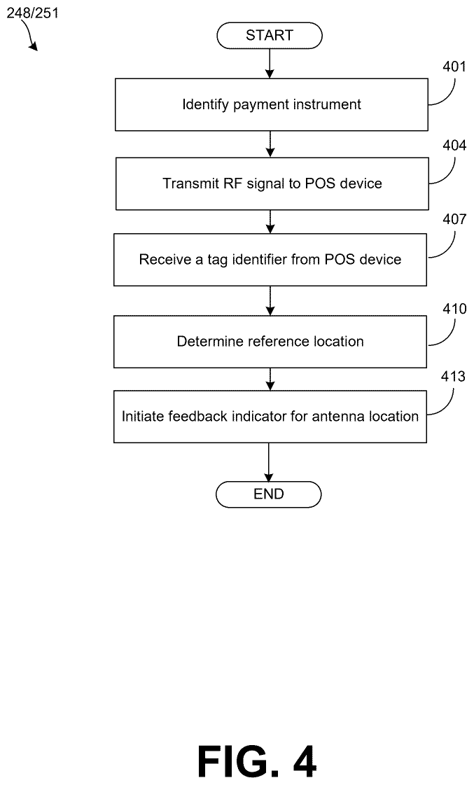

Referring next to FIG. 4, shown is a flowchart that provides one example of the operation of a portion of the wallet application 248. The flowchart of FIG. 4 provides merely an example of the many different types of functional arrangements that can be employed to implement the operation of the depicted portion of the wallet application 248. As an alternative, the flowchart of FIG. 4 can be viewed as depicting an example of elements of a method implemented within the network environment 100. Alternatively, the flowchart of FIG. 4 can be performed by the client application 251.

Beginning with block 401, the wallet application 248 can identify a selection of a payment instrument. The wallet application 248 can identify the selection of a payment instrument in various manners. For example, the wallet application 248 can identify the selection from a user interface selection, from a default payment instrument setting, or other suitable mechanism. The wallet application 248 can determine to initiate a contactless transaction based at least in part on the selection of the payment instrument.

In block 404, the wallet application 248 can transmit a radio frequency (RF) signal to a POS device 106 using the transceiver 239. The RF signal can be transmitted for engaging in a contactless transaction based at least in part on the selection of the payment instrument using the wallet application 248. In some examples, the wallet application 248 causes the generation of an NFC wireless communication signal as the RF signal sent to the POS device 106. The wallet application 248 can use an NFC transceiver 239 for generating the NFC wireless communication signal.

In block 407, the wallet application 248 can receive, via the transceiver 239, a tag identifier 236 of a wireless tag from the POS device 106, in which the tag identifier 236 indicates is a position of the client device 103 with respect to an antenna for executing a contactless purchase. For example, the POS device 106 can have a first wireless tag (e.g., an NFC sticker tag) that is positioned above an NFC antenna location 113 for the contactless payments and a second wireless tag that is positioned below the NFC antenna location 113 of the POS device 106. In some examples, each wireless tag can include a controller, an antenna, and other suitable hardware components. Additionally, each wireless tag can be a passive device that is energized by the RF signal provided by the client device 103. In other examples, the wireless tags can be powered by the POS device 106 and can be activating emitting RF signals for the client device 103 to capture.

In block 410, the wallet application 248 can determine a reference location on the POS device 106 based at least in part on the tag identifier 236. Continuing the previous example, when the client device 103 receives the first tag identifier 236 of the first NFC wireless tag, then the wallet application 248 can determine the reference position of the client device 103 with respect to the NFC antenna location 113. In this instance, the wallet application 248 can determine that the NFC antenna location 113 is below the present location of the client device 103 because the client device 103 is near the reference location of the first NFC tag.

In some examples, the client device 103 comprises a location detection device 245 can provide location data of the client device 103 to the wallet application 248. For example, the wallet application 248 can identify a location of the client device 103 is within a store location. Based at least in part on the present location of the client device 103, the wallet application 238 can determine a POS device type at the store location. The wallet application 238 can query the terminal inventory data 224 on the device for the POS device types 230 located at the present location of the client device 103.

The wallet application 238 can determine the reference locations available on the POS device types 230 that have been identified for the present location. The wallet application 238 can determine one of the reference locations based at least in part on the first tag identifier 236 received from the POS device 106. In some examples, the wireless tag can provide a direction instruction such that the wallet application 248 can omit determining the POS device type 230.

In block 413, the wallet application 248 can initiate a feedback indicator for the antenna based at least in part on the reference location with respect to an antenna location 113 on the POS device 106. Continuing with the previous example, the wallet application 248 can generate the feedback indicator for providing a moving instruction for guiding the user of the client device 103 toward the NFC antenna location 113. The feedback indicator can represent a direction for moving the client device 103 toward the antenna location 113 on the POS device 106. In some examples, the feedback indicator can comprise at least one of an audible indicator generated by a speaker of the client device 103, a visual indicator of the client device 103, or a haptic indicator generated by a haptic actuator of the client device 103. Then, the wallet application 248 can proceed to the end of the depicted process.

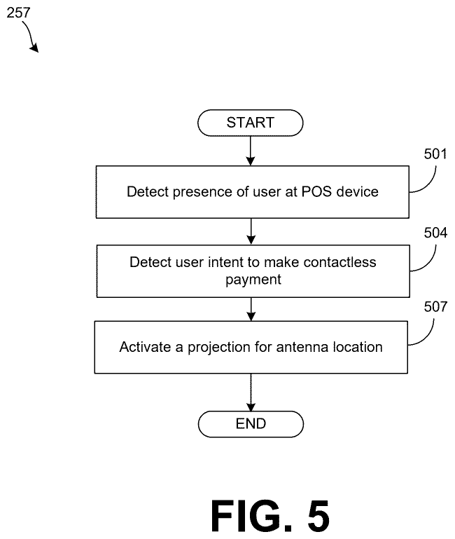

Referring next to FIG. 5, shown is a flowchart that provides one example of the operation of a portion of the merchant application 257. The flowchart of FIG. 5 provides merely an example of the many different types of functional arrangements that can be employed to implement the operation of the depicted portion of the merchant application 257. As an alternative, the flowchart of FIG. 5 can be viewed as depicting an example of elements of a method implemented within the network environment 100.

Beginning with block 501, the merchant application 257 can detect a presence of a user at the POS device 106 using one or more sensors 260. For example, the sensor 260 can be a proximity sensor (e.g., a capacitive proximity sensor, ultrasonic proximity sensor, photoelectric proximity sensor, etc.) that detects the presence of a user at the POS device 106. In other examples, the sensor 260 can be a camera that detects the presence of the user at the POS device 106.

In block 504, the merchant application 257 can detect a user intent to make a contactless payment at the POS device 106. For example, the camera can use object detection techniques to identify the user intent to make a contactless payment, in which hand and arm movements can be identified. In other examples, the sensor 260 is a touch screen and the touch screen receives a selection of using a payment card or making a contactless payment.

In block 507, the merchant application 257 can activate a projection of an antenna location 113 for the POS device 106 using a projector 263. In some examples, the projection can be a three-dimensional projection. The three dimensional projection can have a cube shape, a laser grid arrangement, or other suitable shapes. The projection can have a width dimension of less than four inches. In these examples, the projection is generated for assisting the user with placing a payment instrument at the antenna location 113 for the POS device 106. Upon the payment instrument being placed adjacent to the antenna location 113, the wallet application 248 and the POS device 106 can initiate a contactless payment. The contactless payment can be executed using the contactless network 212 (e.g., an NFC communication protocol). The payment instrument can be a client device 103 executing a wallet application 248, a contactless-based payment card (e.g., an NFC-based physical payment card), and other suitable contactless payment instruments. The contactless payment can represent a Europay, Mastercard, and Visa (EMV) contactless payment protocol. Then, the merchant application 257 can proceed to the end of the depicted process.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client device comprising a processor and a memory;
a camera in data communication with the client device; and
machine-readable instructions stored in the memory that, when executed by the processor, cause the client device to at least:
identify intent to initiate a transaction with a point-of-sale (POS) device;
initiate an image stream using the camera to capture a view of the POS device;
identify a POS device type of the POS device in the image stream based at least in part on a visual object detected in the image stream;
determine an antenna location for the POS device based at least in part on the POS device type and an inventory of POS terminals; and
augment the image stream to include a visual terminal indicator for a terminal antenna field based at least in part on the antenna location of the POS device.

2. The system of claim 1, wherein the machine-readable instructions further cause the client device to at least:
augment the image stream to include a visual device indicator representing a device antenna field of the client device.

3. The system of claim 2, wherein the machine-readable instructions further cause the client device to at least:
generate a feedback indicator that provides a moving instruction for overlapping the visual device indicator with the visual terminal indicator.

4. The system of claim 1, wherein the visual terminal indicator is represented as at least one of a portion of a spherical shape, or a cube shape based at least in part on the antenna location.

5. The system of claim 1, wherein the identification of the POS device type of the POS device in the image stream is further based at least in part on a computer vision model that is trained on identifying a visual component of a plurality of POS terminals.

6. The system of claim 1, wherein the machine-readable instructions further cause the client device to at least:
initiate a contactless purchase using a wallet application based at least in part on a position of the client device with respect to the visual terminal indicator.

7. The system of claim 1, further comprises a location detection device in data communication with the client device, and wherein the identification of the POS device type of the POS device in the image stream is further based at least in part on a location for the client device within a store location.

8. A method, comprising:
identifying, by a client device, an indication to initiate a transaction with a point-of-sale (POS) device;
initiating, by the client device, an image stream using a camera of the client device to capture a view of the POS device;
identifying, by the client device, a POS device type of the POS device in the image stream based at least in part on a visual object detected in the image stream;
determining, by the client device, an antenna location for the POS device based at least in part on the POS device type and an inventory of POS terminals; and
augmenting, by the client device, the image stream to include a visual terminal indicator for a terminal antenna field based at least in part on the antenna location of the POS device.

9. The method of claim 8, further comprising:
augmenting, by the client device, the image stream to include a visual device indicator representing a device antenna field of the client device.

10. The method of claim 9, further comprising:
generating, by the client device, a feedback indicator that provides a moving instruction for overlapping the visual device indicator with the visual terminal indicator.

11. The method of claim 8, wherein the visual terminal indicator is represented as at least one of a portion of a spherical shape, or a cube shape based at least in part on the antenna location.

12. The method of claim 8, wherein identifying the POS device type of the POS device in the image stream is further based at least in part on a computer vision model that is trained on identifying a visual component of a plurality of POS terminals.

13. The method of claim 8, further comprising:
initiating, by the client device, a contactless purchase using a wallet application based at least in part on a position of the client device with respect to the visual terminal indicator.

14. The method of claim 8, wherein identifying the POS device type of the POS device in the image stream is further based at least in part on a location for the client device generated by a location detection unit.

15. A system, comprising:
a client device comprising a processor and a memory;
a transceiver in data communication with the client device; and
machine-readable instructions stored in the memory that, when executed by the processor, cause the client device to at least:
identify a selection of a payment instrument from a wallet application;
transmit a radio frequency signal to a POS device using the transceiver;
receive, via the transceiver, a tag identifier from the POS device, the tag identifier indicating a position of the client device with respect to an antenna for executing a contactless purchase;
determine a reference location on the POS device based at least in part on the tag identifier; and
initiate a feedback indicator for the antenna based at least in part on the reference location with respect to an antenna location on the POS device.

16. The system of claim 15, wherein the transceiver is a near field communication transceiver.

17. The system of claim 15, wherein the feedback indicator represents a direction for moving the client device toward the antenna location on the POS device.

18. The system of claim 15, wherein the feedback indicator represents a distance between the client device and the antenna location on the POS device.

19. The system of claim 15, wherein the feedback indicator is at least one of an audible indicator generated by a speaker or a haptic indicator generated by a haptic actuator.

20. The system of claim 15, further comprising:
a location detection device that is in data communication with the client device;
wherein the machine-readable instructions, when executed by the processor, further cause the client device to at least:
identify a location of the client device within a store location using the location detection device;
determine a POS device type based at least in part on the location of the client device within a store location; and
wherein the reference location on the POS device is further determined based at least in part on the POS device type.
